(19) United States
(12) Patent Application Publication
(10) Pub. No.: US 2010/0008484 A1
(43) Pub. Date: Jan. 14, 2010

(54) REAL-TIME FLEXIBLE ACCOUNT SELECTION FOR COMMUNICATIONS

(75) Inventors: Andreas ABRAHAMSSON, KARLSKRONA (SE); Johannes SILVANDER, KARLSKRONA (SE); Robert TORNKVIST, KARISHAMN (SE); Joachim WAHLBERG, BRAKNE-HOBY (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET L M ERICSSON (PUBL), Stockholm (SE)

(21) Appl. No.: 12/171,641

(22) Filed: Jul. 11, 2008

(51) Int. Cl. H04M 15/00

(52) U.S. Cl. 379/121.03

(57) ABSTRACT

A communications system (20) and method of operation thereof charges a call to at least one of plural customer accounts. A basic method comprises receiving a user identifier from a communications network in conjunction with a communications call or session, using an account-based filter to make a determination whether the call, having a user identifier which is associated with a first account, should be alternatively or partially associated with a second account instead of the first account. The filter can make the determination based on a characteristic of the call. In differing or combinations of embodiments, the characteristic of the call can be (by way of non-limiting example) at least one of type of service utilized by the call; time of the call; location of a party to the call; particular user identity employed at authentication of the call.

### TECHNICAL FIELD

This invention pertains to communications, and particularly to methods and apparatus for accounting and/or charging for services rendered by communications companies and utilized by communication customers.

### BACKGROUND

Communications companies (e.g., telecommunications operators) issue financial charges to customers in return for services rendered. The revenue realized by communications companies upon customer payment (whether in advance or after service) defrays, among other things, the initial capital outlay and maintenance of the network infrastructure, as well as day-to-day operating costs.

Some customers may pay a flat fee for communications services. Most customers have an account which is established by a contract or fee arrangement/agreement. Typically a customer's account is structured or arranged, at least in part, so that the customer is assessed a communications fee which is dependent upon an amount of time or other network resource which is utilized by the customer (e.g., degree or quality of service, calendar or clock time of service, for example). The fee or charge typically either reduces a prepaid amount existing in the customer's account, or accumulates against the credit of the customer and is presented for subsequent payment.

For charging purposes the communications network provides some type of monitoring of resource consumption by the customers. The monitoring can occur at faculties or nodes involved in setup or administration of the services (e.g., of a call or connection). The resource monitoring and/or other types of reports from the communications network are communicated to a real-time charging system which associates the call or session with a customer's account as maintained by the charging system, and may send reports (e.g., Call Detail Record (CDR) files) to an off-line billing system which is maintained by the communications operator. The billing system likewise has an off-line account which is associated with the customer, and which includes other (e.g., historical information).

A billing system connected directly to the communications equipment without a real-time charging system lacks the possibility of providing real-time credit control (to protect the operator) and real-time spending control (to protect the end-user). In such case the billing systems only acts upon historical records received from the communications equipment (e.g., telecom equipment). The billing system by itself might be able to handle complex relations between accounts and services, but unless connected to a real-time charging system would lack the benefit of handling the balance and usage in real-time.

Real-time accounts of a real-time charging system can hold different “buckets” or subaccounts, each with a reserved amount, that can only be used for a specific service, e.g. SMS, GPRS etc. In a real-time charging system there may also be accumulators for measuring and reporting spending per service connected to the account.

As mentioned above, the charging system maintains an account for a customer, at least during the life of the call, connection, or session involving the customer. (The terms call, connection, and session are utilized interchangeably herein). The account is connected to (e.g., associated with or identified by) a user identifier or user identity such as, e.g. MSISDN (Mobile Subscriber Integrated Services Digital Network Number) or SIP URI (Session Initiation Protocol Uniform Resource Identifier).

A communications account can, in turn, have subaccounts for a specific service, like download of music, for example, in order for a customer to partition or itemize transactions according to a certain criteria (such as type of service utilized, for example). Similarly, some customer accounts (such as corporate accounts) are structured so that charges are split or classified by departments. Some household customer accounts are partitioned for billing purposes to be able to associate charges with family members or individuals.

Unfortunately, existing real-time charging systems can only handle accounts which involve certain limited relationships between a user identity (the identity such as MSISDN) used for a particular service and the real-time account holder (customer). The traditional limited relationships are either (1) a fixed one-to-one relation, or (2) a many-to-one relation. The relationships (e.g., “relations”) are configured once and thereafter are considered valid for all charging scenarios where the user uses the same identity. The traditional charging system thus focuses on the particular identity the user is using as the criteria for selecting an account or account structure. This means that when a user (e.g., a human individual) employs a different identity for a communications service than another identity associated with the individual, the individual is deemed to be a completely different user.

### SUMMARY

In one of its aspects the present technology concerns a method of operating a communications system to charge a call to one or more customer accounts. The term “call” is used throughout the description may be used interchangeably for event, session, services, etc. Basically, the method comprises receiving a user identifier from a communications network in conjunction with a communications call or session (the user identifier being associated with a first account), using a filter for the first account to make a determination whether the call should (alternatively or partially) be associated with a second account; and charging the call to at least one of the customer accounts in accordance with the determination. Preferably the first filter associated with the first account makes the determination based, at least in part, on a characteristic of the call. In differing embodiments, the characteristic of the call can be (by way of non-limiting example) at least one of type of service utilized by the call; time of the call; location of a party to the call; particular user identity employed at authentication of the call.

An example mode of the method includes initially associating the call to a first account in accordance with the user identifier employed by a party participating in the call. The example mode further comprises using the first filter for the first account to determine, based on the characteristic, whether the call should alternatively or partially be associated with the second account. If the first filter indicates that the call should be associated with the second account, the example mode uses a second filter of the second account to make a confirmation whether the second account can be associated to the first account. If the confirmation can be made, the call is charged (at least partially) to the second account. If the confirmation cannot be made, the call is charged to the first account.

Another aspect of the present technology concerns a charging system for a communications system. The charging system comprises an information storage database (comprising plural customer accounts); account selection logic; and an account charging unit. The account selection logic comprises account-based filters which are configured to make a determination whether the call, having a user identifier which is associated with a first account, should be alternatively or partially associated with a second account. The account charging unit is configured to develop financially related information for the call. In an example embodiment a first filter for a first account makes the determination based on a characteristic of the call. In potentially differing embodiments, the characteristic of the call can be at least one of type of service utilized by the call; time of the call; location of a party to the call; particular user identity employed at authentication of the call.

In an example embodiment, the account selection logic comprises a set of filters comprising a first filter for the first account which is configured initially to associate the call to a first account in accordance with the user identifier and to determine, based on the characteristic, whether the call should alternatively or partially be associated with the second account. The account selection logic is further configured, if the first filter indicates that the call should be associated with the second account, to comprise a second filter of the second account which is configured to make a confirmation whether the second account can be associated to the first account. If the confirmation can be made, the account selection logic is configured to direct the charging unit to charge the call to the second account. If the confirmation cannot be made, the account selection logic is further configured to direct the charging unit to charge the call to the second account.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a diagrammatic view showing plural example contact identifiers associated with a representative user.

FIG. 2 is a diagrammatic view showing plural example roles potentially played or fulfilled by a representative user.

FIG. 3 is a diagrammatic view of an example, generic embodiment of a communications system suitable for real-time flexible account selection technology.

FIG. 4 is a diagrammatic view showing an embodiment of account selection logic that comprises a filter function.

FIG. 5 is a diagrammatic view showing a scenario of operation of a user of FIG. 1 in the communications system of FIG. 3.

FIG. 6 is a flowchart showing basic, example steps or acts involved in a generic method of real-time flexible account selection.

FIG. 7 is a flowchart showing basic, example steps or acts performed in an example mode by account selection logic of the system of FIG. 3.

FIG. 8 is a diagrammatic view of an example, detailed embodiment of a communications system suitable for real-time flexible account selection technology.

FIG. 9 is a flowchart showing basic, example steps or acts performed in an example mode by account selection logic of the system of FIG. 8.

FIG. 10 is a diagrammatic view of an example, detailed embodiment of a real-time charging system in which filters are configurable, e.g., by an account owner.

FIG. 11 is a diagrammatic view of an example, detailed embodiment of a real-time charging system in which one or more filters comprise or have access to financial manager/accumulator.

FIG. 12 is a diagrammatic view of an example embodiment of account selection logic which provides an account redirection capability.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks labeled or described as “processors” or “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared or distributed. Moreover, explicit use of the term “processor” or “controller” should not be construed to refer exclusively to hardware capable of executing software, and may include, without limitation, digital signal processor (DSP) hardware, read only memory (ROM) for storing software, random access memory (RAM), and non-volatile storage.

As used herein and illustrated by FIG. 1, a user 10, also called a “party”, can be any natural or physical person or entity (e.g., human being) or legal person or entity (e.g., organization or corporation). The user 10 is identified by a “party ID” (PID). In the case of a natural or physical person, the party ID (PID) can be a number such as a social security number, for example. In the case of a legal person or entity, the party ID (PID) can be a suitable corporate or organization identifier, such as a taxpayer ID number, for example.

FIG. 1 further shows that user 10 can be assigned or associated with one or more contact identities (CIDs). Each contact identify (CID) can be an identifier or user name or a network number or the like through which can be used by user 10 to gain access to a communications service. As a non-exhaustive and merely illustrative example, FIG. 1 shows user 10 has being associated with CID1 (for email protocol); CID2 (for Session Initiation Protocol [SIP]), and CIDn (for MSISDN). The term “user identifier” as used herein encompasses or includes one or both of party ID (PID) and contact identity (CID).

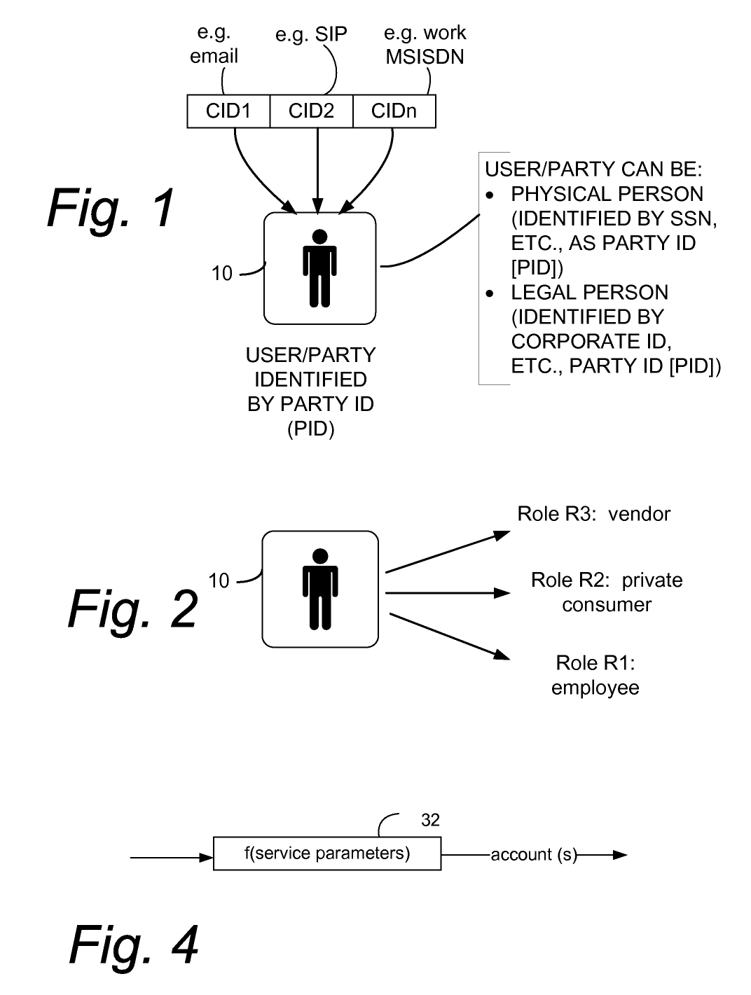

FIG. 2 illustrates that user 10 may fulfill or play one or more roles in conjunction with his/her communications activities. In a first role (R1), user 10 can be an employee. In a second role (R2) user 10 can be a private consumer. In another role (R3) the user 10 can be a vendor. These three roles are provide only by way of example, other roles are possible and the nature and number of roles may vary from user to user.

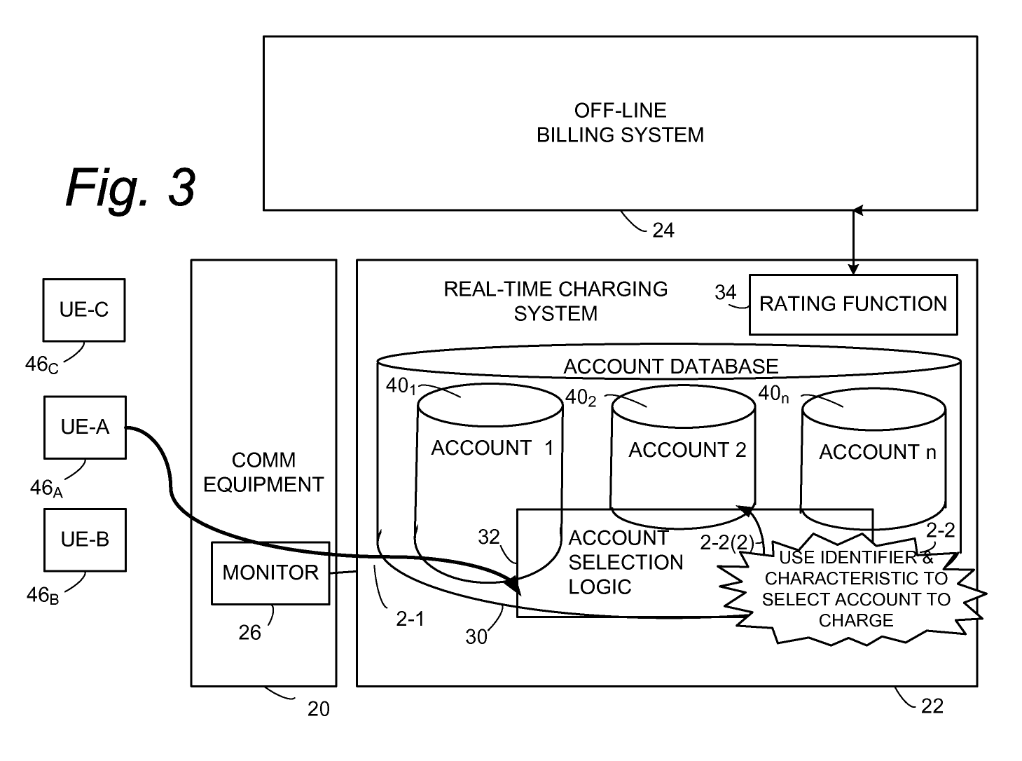

FIG. 3 shows an example communications system comprising a communications network 20 which has access to a real-time charging system 22 and, through real-time charging system 22, to off-line billing system 24. The communications network 20 can be or comprise any type or radio access network or other type access network, alone or in combination with one or more core networks, and is typically provided and/or maintained, or is available for use, by a communications company or communications operator (e.g., telecommunications company or telecommunications operator) which provides services to customers or subscribers in exchange for payment. The communications network 20 can thus be or comprise, as examples, a network of a type known as the Universal Mobile Telecommunications (UMTS) Terrestrial Radio Access Network (UTRAN), a Global System for Mobile communications (GSM) type network, an Advance Mobile Phone Service (AMPS) type system; a Narrowband AMPS type system (NAMPS); a Total Access Communications type system (TACS); a Personal Digital Cellular (PDS) type system, an EDGE system, just to name a few different types of radio access networks. The communications system 20 is not limited to wireless communication system but may be any type of, or combination, of data and/or telecommunication systems as fixed line telecommunication networks, IP Multimedia Subsystem (IMS), WLAN, Diameter/Content/Service delivery as specified by 3GPP.

The real-time charging system 22 and off-line billing system 24 can, at least in some embodiments, comprise or be included in nodes or elements of communications network 20. However, as shown in FIG. 3, real-time charging system 22 and off-line billing system 24 are typically situated at nodes or service points which are external to communications network 20. As used herein, a service point or any other site or facility which performs the functions herein described for either real-time charging system 22 or off-line billing system 24 are included in the concept of “node”, whether such node or service point is dedicated for the charging/billing function or happens to perform functions in addition to the charging/billing function. Appropriate signaling connections and signaling protocols are established between communications network 20 and real-time charging system 22, as well as between real-time charging system 22 and off-line billing system 24. For example, communications equipment 20 may send call detail records (CDRs) in an off-line manner to the off-line billing system 24, or signal in real time with the real-time charging system 22. The transmission of call detail records (CDRs) between the real-time charging system 22 and the off-line billing system 24 is an issue in a converged system (e.g., for providing postpaid customer with real time spending control).

FIG. 3 illustrates generically (by communications activity monitor 26) a capability of communications system 20 to monitor communications activity, e.g., set-up, termination, and intermediate events for calls and connections involving subscribers, and to obtain and/or signal information to real-time charging system 22 with respect to such activity. Thus, the communications activity monitor 26 communicates with real-time charging system over an appropriate link and protocol. The communications activity monitor 26 is configured to consult real-time charging system 22 and/or off-line billing system 24 upon attempted set up of a call or connection (e.g., a transaction) involving a subscriber, and upon approval and successful set up to provide to real-time charging system 22 and/or off-line billing system 24 information germane to the subscriber or the subscriber's account. Such information can be generated by communications activity monitor 26, not only upon set up of a connection, but also at termination of the call or connection as well as intermediate points in between. The information can be for example the contact identity CID as user identifier (e.g., MSISDN (Mobile Subscriber Integrated Services Digital Network Number), a SIP URI (Session Initiation Protocol Uniform Resource Identifier) or an email address of the party participating in the call, and can further include or pertain to duration or time of the call or connection, or other aspects or parameters of the call of connection, such as type of service provided, quality of service provided, security or spatial policy, e.g., rights management, etc. Of course, communications activity monitor 26 provides its information for multitudinous subscribers, and for repeated calls or connections of such subscribers on an on-going basis. The communications activity monitor 26 thus typically represents numerous reporting agents comprising or interspersed within communications network 20, which can be situated at various locations throughout communications network 20. Alternatively, at least in some embodiments, some or all functions of communications activity monitor 26 can also be considered part of real-time charging system 22.

A generic, representative, real-time charging system 22 as shown in FIG. 3 comprises information storage database 30 (also known as real-time account database 30); account selection logic 32; and rating function 34. As further shown in FIG. 3, real-time account database 30 comprises plural customer accounts 40, e.g., records for plural customer accounts. For example, real-time account database 30 comprises account 40₁ for customer #1; account 40₂ for customer #2; account 40ₙ for customer #n; and so forth. Each account 40 can include, for example, a real-time account balance for the corresponding customer.

As generally illustrated in FIG. 4, account selection logic 32 is configured to make an assignment of a communications (e.g., telecommunications) call or session to a selected one or more of plural accounts 40. The account selection logic 32 can, in an example embodiment, include a filter function or the like which receives input in the form of one or more service parameters (including the call characteristic) and makes the determination as to which account(s) should be charged. The filter function may fetch additional parameters from elsewhere for such purposes as (for example) number portability, location, etc., for a balance in available candidate accounts. The account(s) to be charged as determined by the filter function may belong to any party, including the originating user (e.g., user 10).

The rating function 34 is configured to calculate the charge rate for the selected call or service, such that an account can be accurately adjusted to reflect the cost of the call/service.

For sake of simplified illustration, FIG. 3 shows three units connected to communications network 20: user equipment (UE-A) 46_{A}, user equipment (UE-B) 46_{B}, and user equipment 46_{C}. It will be appreciated that communications network 20 typically serves multitudinous users and/or devices.

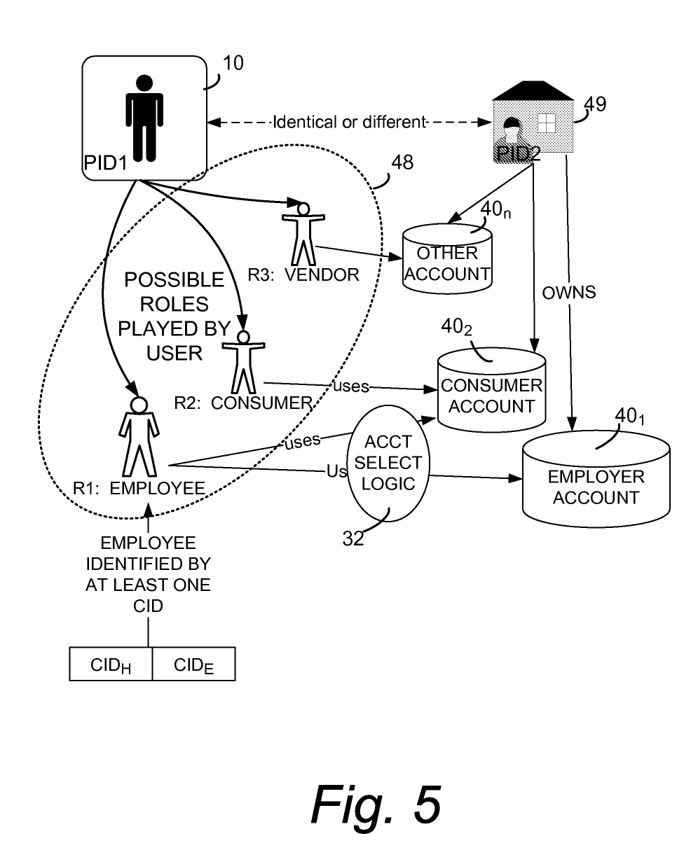

FIG. 5 illustrates a scenario of operation for a user such as user 10 situated in the context of a communications network such as communications network of FIG. 3. FIG. 5 shows (by broken line 48) that user 10 can play either of the three example roles shown in FIG. 2: the Role R1 of an employee; role R2 of a private consumer; role R3 of a vendor (among other possible roles).

At the time shown in FIG. 5, user 10 is identified by party ID PID1. Another party ID is also shown in FIG. 5, i.e., party ID PID2. In one example embodiment and mode discussed hereinafter, this other party ID (PID2) can be owned by another entity 49, e.g., owned by the employer of user 10. In another example embodiment and mode, this other party ID (PID2) can also be owned by user 10 (as an alias or additional personal identifier). In the latter embodiment and mode, having an additional personal identifier can be useful to a user or party if the user desires to debit different accounts for different services, etc., or otherwise have some differentiation or categorization in his business affairs.

Suppose in the scenario shown in FIG. 5 that user 10 has two contact identities: (1) a first contact identity CID_{H} for home use (home location) or in his/her personal consumer role; and (2) a second contact identity CID_{E} for his/her work location/use (the contact identity afforded to the user 10 by his/her employer). The first contact identity CID_{H} and the second contact identity CID_{E} can be different MSISDN values, for example. As shown in FIG. 5, account 40₂ is associated with the home contact identity CID_{H} and therefore is paid by user 10. On the other hand, a work account 40₁ is paid by the company/employer.

Suppose further, for the scenario of FIG. 5, that while at work (e.g., on the premises of an employer), user 10 wishes, for personal reasons, to access or use a particular communications service (e.g., a music download) which is unrelated to his professional activities, and in so doing uses his work contact identity CID_{E} (the contact identity allocated to user 10 by this employer) to access the particular communications service (e.g., the music download). The access by user 10 can be in any of several manners, including access using a wireless terminal (e.g., a mobile station, cell phone, or user equipment unit, for example) or using a wired terminal (such as computer, for example).

In conventional practice, no matter what service the user 10 uses, when user 10 employs the work contact identifier CID_{E} as the contact identifier to access a service, the charging for the service will still be made to the employer's account 40₁ and therefore paid by the company/employer. In conventional practice the charging may be settled later between the company and employee in another transaction not handled by the billing system, but from an operator perspective the user 10 and the company represents the same party.

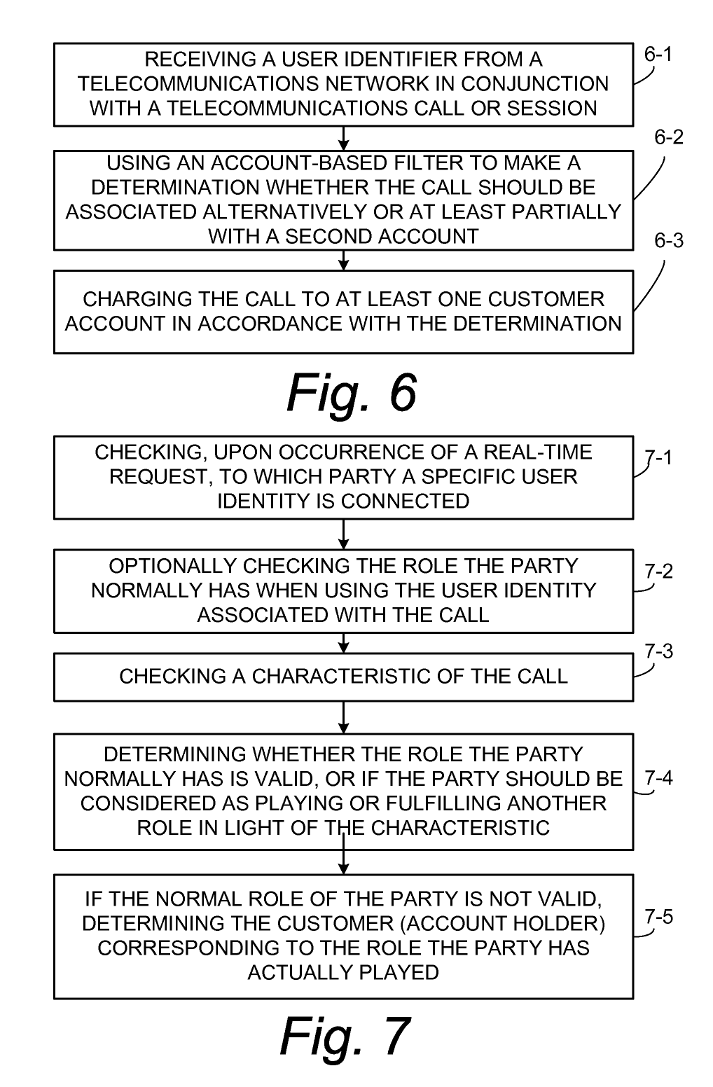

The present technology surpasses conventional practice by providing method and apparatus for performing such activities as, e.g., alternatively or at least partially charging the home account of user 10 for a service access for personal use by user 10 when using the employer/work contact identity CID_{E} (i.e., using the work MSISDN). Basic, representative acts or steps of the method are illustrated in FIG. 6.

Act 6-1 of FIG. 6 (see also FIG. 3) comprises receiving a user identifier from a communications network in conjunction with a communications call or session. As used herein, a “user identifier” encompasses or includes one or both of party ID (PID) and contact identity (CID). For example, in the example scenario discussed above with reference to FIG. 5, act 6-1 can involve user 10 using his/her work contact identifier CID_{E} while at work to access a personal service (e.g., music download, for example). The employment account associated with the work contact identifier CID_{E} for the service access happens to be illustrated in FIG. 3 and FIG. 5 as account 40₁. The user 10 also has a home account which is represented in FIG. 3 and FIG. 5 by account 40₂. The particular identifier utilized for the call (in this case the work contact identity CID_{E}) and the particular service accessed (which, in this scenario is a non-limiting example of a “characteristic” of the call) are relayed to real-time charging system 22, e.g., by communications activity monitor 26 in an example embodiment, so that real-time charging system 22 receives the user identifier. The call characteristic can also be obtain from other sources, such as an application servers or a communication switch, for example.

As used herein, a call “characteristic” is any information related to a call that facilitates a determination regarding which of plural possible accounts should be charged for the call. In differing or combinations of embodiments, the characteristic of the call can be (by way of non-limiting examples) at least one of type of service utilized by the call; time of the call; location of a party to the call; particular party identifier (PID) employed at authentication of the call

Act 6-2 of the method of FIG. 6 comprises account selection logic 32, and particularly a filter comprising the first account, using the user identifier and a characteristic of the call to make a determination, based on a characteristic of a call, whether the call, having a user identifier which is associated with a first account, should be alternatively or at least partially associated with a second account. That is, in the example scenario of FIG. 5, as act 6-2 the first filter associated with the first account of account selection logic 32 determines whether, based on the fact that the service is a music download (which fact is a characteristic of the call), should be associated with home or personal account 40₂ for user 10, even though the contact identity CID_{E} utilized by user 10 for the call would tend to indicate that employer account 40₁ would be charged. Thus, in the example of FIG. 3 and FIG. 5, the call characteristic utilized by account selection logic 32 is the type or nature of service utilized (e.g., a musical download). Discernment of whether the type of service involved in the call should be charged to account 40₁ or account 40₂ can be made by account selection logic 32 consulting a directory or database of services which are authorized by one or the other accounts, e.g. a directory of services authorized by or permitted for account 40₁.

For example, in the scenario discussed above wherein user 10 uses his work contact identity CID_{E} to download music, account selection logic 32 can initially determine that account 40₁ is associated with the particular (work) contact identity [CID_{E}] utilized by user 10. But also realizing that the particular service (music download) is not a service that should be charged to account 40₁, the account selection logic 32 can instead charge the cost of the music download service to the home account of user 10, e.g., account 40₂. Accordingly, FIG. 3 shows by arrow 2-2(2) a charging to home account of user 10, e.g., account 40₂.

Thus, the present technology has the perspective that “user” is just a role that a specific party can take or play. It might as well take the role of a customer (i.e. the account holder). What role a party takes may depend on a number of things, like what service is used, identity used at authentication, or time of day. These roles can be reflected by the “characteristic” of the call, as discussed above.

The present technology and account selection logic 32 in particular encompasses a general procedure or method which includes the acts illustrated in FIG. 7.

Act 7-1 of the generalized procedure of account selection logic 32 comprises checking, upon occurrence of a real-time request, to which party a specific user identity utilized in/associated with the call is connected. For example, when the work contact identity CID_{E} of user 10 is utilized, account selection logic 32 associates the work contact identity CID_{E} with user 10. This assumes that user 10 is disconnected from the user identities that are used for authorization and connection.

Act 7-2 comprises optionally checking the role the party normally has when using the user identity associated with the call, e.g., used to place the call (e.g., checking whether user 10 normally fulfills the role of employee when using his/her work contact identity CID_{E}).

Act 7-3 comprises checking a characteristic of the call, e.g., checking the type of service the party is trying to access, location, time of day etc.

Act 7-4 comprises determining whether the role the user 10 normally has is valid, or if user 10 should be considered as playing or fulfilling another role in light of the information obtained in the previous act (e.g., depending on the characteristic of the call). For example, act 7-4 involves determining whether, in view of the characteristic of the call placed by user 10, the user 10 46₁ can correctly be considered to play its default role of employee or worker.

If the normal role of the party is not valid, act 7-5 comprises determining the customer (account holder) corresponding to the role the party has actually played, e.g., a role other than the default role for the utilized identifier.

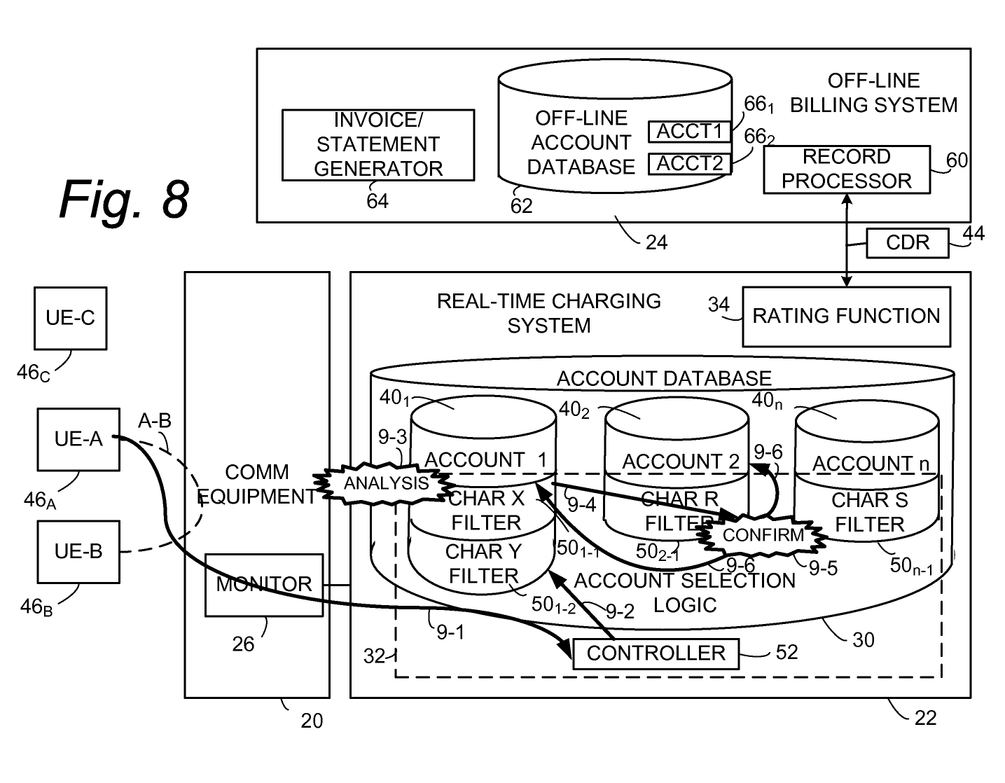

FIG. 8 shows an example, more detailed embodiment of a communications system suitable for real-time flexible account selection technology. FIG. 8 has comparable reference numerals for essentially same components and/or units as described in FIG. 3, but shows more details for, e.g., an example embodiment of account selection logic 32 and of off-line billing system 24.

The account selection logic 32 is shown as including a set of filters 50, with one or more accounts 40 of real-time account database 30 having one or more filters 50. In other words, associated or linked to at least some of the accounts 40 are one or more filters 50. The filters 50, also known as “characteristic” filters, provide criteria and/or code which can serve as input to account selection logic 32. For example, filter 50₁₋₁ (also known as service filter X) and filter 50₁₋₂ (also known as service filter Y) comprise or are associated with account 40₁; filter 50₂₋₁ (also known as service filter R) comprise or is associated with account 40₂; and filter 50ₙ₋₁ (also known as service filter S) is associated with account 40ₙ. In addition, in the example embodiment of FIG. 8 the account selection logic 32 also comprises controller 52. It should be appreciated that account selection logic 32 in one or more embodiments can thus take the form of or at least include a processor or controller as those terms are herein expansively explained.

The filters 50 can, at least in one example embodiment, comprise code, scripts, or other information executable or usable by controller 52 for selecting an appropriate account to which a call, connection, or session is to be charged. Such information can, as in the illustrated example embodiment, be stored in real-time account database 30 in association with the particular account 40 to which the filter pertains. While FIG. 8 shows the filters 50 as being stored in real-time account database 30, it should be appreciated that the filters 50 can be stored in other memory and yet be associated or linkable to the respective accounts 40.

FIG. 8 also shows example details of a generic, representative, off-line billing system 24 of the type shown in FIG. 3. The example off-line billing system 24 of FIG. 8 comprises record processor 60; off-line account database 62; and, invoice/statement generator 64. The record processor 60 receives and processes the CDR-type reports which are generated by rating function 34 of real-time charging system 22. Off-line account database 62 is configured to maintain an off-line, non-real-time account (and thus an off-line account balance) for subscribers. For example, off-line account database 62 comprises off-line account 66₁ which is maintained essentially in parallel with account 40₁ and off-line account 66₂ which is maintained essentially in parallel with account 40₂. It will again be appreciated that off-line account database 62 of off-line billing system 24 comprises accounts for myriad subscribers, of which off-line accounts 66₁ and 66₂ are but two examples.

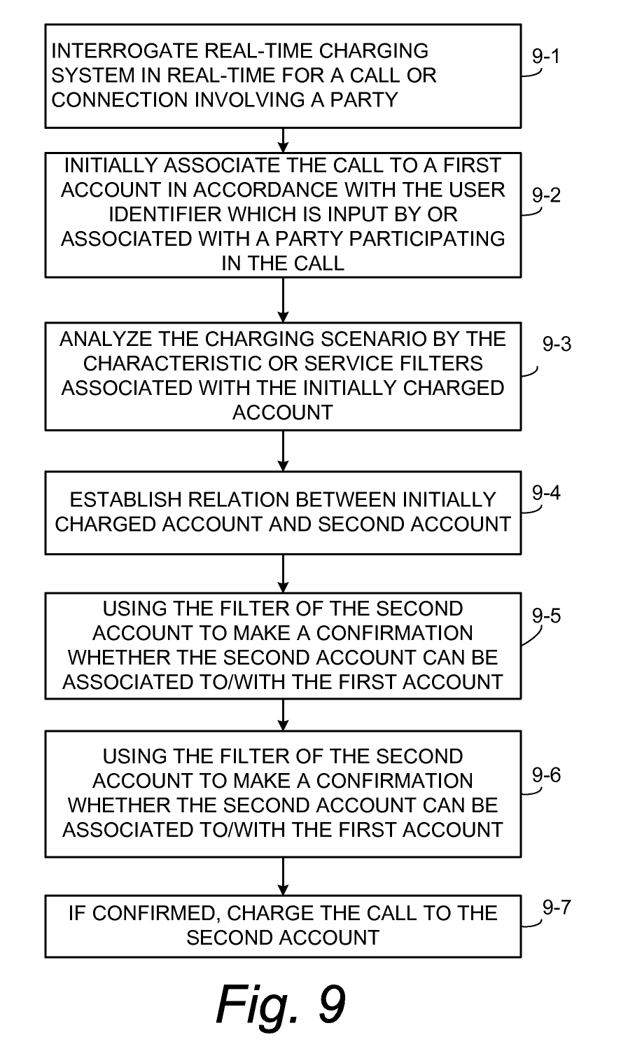

FIG. 9 together with FIG. 8 represents certain example, representative, basic acts or steps performed in implementing a mode of the method particularly suitable for an embodiment such as that of FIG. 8. As act 9-1, communications network 20 interrogates real-time charging system 22 in real-time for a call or connection involving a party. Such interrogation can happens at start of a call/session (first interrogation) and during the session (intermediate interrogation). In the illustrated example of FIG. 8, the call or connection involves user 10, who is using his work contact identity CID_{E} to make a call on user equipment unit (UE-A) 46_{A} for his private or personal benefit (a call not pertinent to his work or employment). In particular, user 10 using user equipment unit (UE-A) 46_{A} attempts to make a personal call to a call recipient at (UE-B) 46_{B}, as depicted by line A-B in FIG. 8.

Act 9-2 comprises account selection logic 32 locating (in real-time account database 30) the appropriate real-time account by using the user identity received from telecom/end-user equipment. In other words, act 9-2 comprises initially associating the call to a first account in accordance with the user identifier which is input by or associated with a party participating in the call. In this illustrated scenario, since user 10 is using his work contact identity CID_{E}, as act 9-2 the account selection logic 32 selects account 40₁ as part of act 9-2.

Act 9-3 of the mode of FIG. 9 comprises analyzing the charging event using (e.g., in consultation with) the filters associated with the initially charged account. Since account 40₁ was selected as the initially charged account by act 9-2 in the illustrated scenario, filter 50₁₋₁ (also known as service filter X) and filter 50₁₋₂ (also known as service filter Y) which comprise or are associated with account 40₁ are used, e.g., in act 9-3, in the analysis of the charging event. In the case that the criteria or information of service filter 50₁₋₁ matches the charging scenario (e.g., the filter 50₁₋₁ ascertains or detects information indicating the characteristic of a personal call), a relation between account 40₁ and another account is established. That is, a relation is established between the initially charged account and a second account. As indicated before, user 10 has as his personal account the account 40₂. Therefore, as a result of the analysis of act 9-3, a relation is established by account 40₁ and account 40₂, as indicated by act/arrow 9-4 of FIG. 8 and FIG. 9. Thus, act 9-4 represents using a first filter (e.g., filter 50₁₋₁) for the first account (account 40₁) to determine, based on the characteristic, whether the call should instead be associated with a second account (such as account 40₂, for example).

Had the filters associated with account 40₁ not established a relation with another account, the call would remained charged to the initially charged account, i.e., account 40₁.

Act 9-5 through act 9-7 can be performed as optional steps of the mode of FIG. 9, for which reason act 9-5 through act 9-7 are shown by broken lines in FIG. 9. Act 9-5 through act 9-7 capitalize upon the fact that the second account (e.g., account 40₂ in the illustrated scenario) owns its own (usually different) set(s) of service filter(s). In the illustrated scenario, account 40₂ owns or has access to filter 50₂₋₁ (also known as service filter R). Act 9-5 comprises using the filter (e.g., filter 50₂₋₁) of the second account (account 40₂) to make a confirmation whether the second account can be associated to/with the first account (e.g., account 40₁). If the confirmation can be made, the call is charged to the second account, as represented by act 9-6 of FIG. 9.

If the confirmation of act 9-5 cannot be made, the call is charged elsewhere, e.g., to the first account (e.g., account 40₁), as represented by act 9-7 of FIG. 8 and FIG. 9. Alternatively, the call could also be cancelled.

Thus, in the example scenario of FIG. 8, service filter 50₂₋₁ is indeed valid for an interrogation from account 40₁, and may possibly be valid from other accounts as well. When the charging event matches the criteria or information of service filer (R), the interrogation is executed towards account 40₂ as depicted by arrow 9-6.

Although not shown in FIG. 8, the charging of the event to account 40₂ will result in creation by rating function 34 of one or more records (e.g., CDRs) 44. Record(s) 44 are that are received and processed by record processor 60, and applied or utilized in conjunction with off-line account 66₂ which is the home account for party/user (UE-A) 46_{A}. Subsequently an invoice, bill, or statement is prepared for party/user (UE-A) 46_{A} concerning account 66₂ by invoice/statement generator 64.

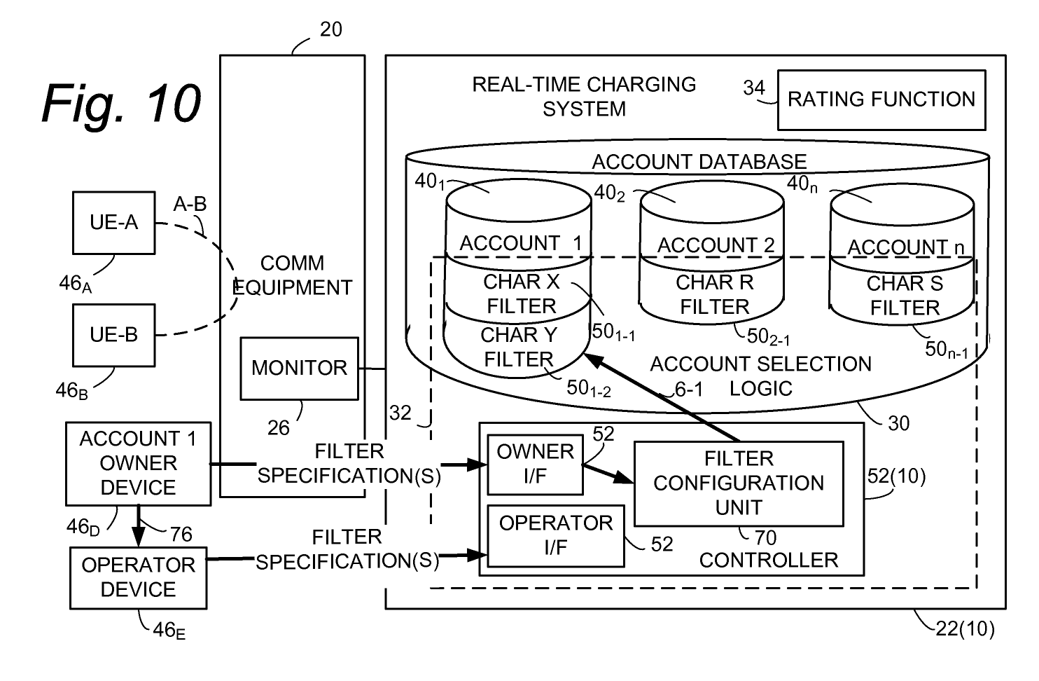

FIG. 10 illustrates an embodiment of a real-time charging system in which the filters 50 are configurable, e.g., by an account owner. In particular, FIG. 10 shows real-time charging system 22(10) in which an account owner can interactively configure (e.g., input, modify, delete) information (e.g., data, criteria, rules, scripts, code) included in or associated with one or more of the filters 50 of real-time account database 30. The particular situation of FIG. 10 depicts an owner device 46_{D}, which happens to belong to or be utilized by the owner of account 40₁ (e.g., the employer of user 10 who uses user equipment unit (UE-A) 46_{A} in the above-described scenario). The owner device 46_{D} connects to real-time charging system 22 through communications network 20, and thus can be (for example) any time of communications device, including but not limited to a landline phone, a wireless device, or a computer connected by a suitable protocol such as Internet Protocol, for example.

The account selection logic 32 of FIG. 10 (and particularly controller 52(10) in a non-limiting example embodiment) comprises filter configuration logic 70. The filter configuration logic 70 can receive inputs from and interact with various interfaces, such as owner/telcom interface 72 and operator interface 74. The owner/telcom interface 72 serves as an interface or port through which filter configuration logic 70 of controller 52(10) receives filter specifications (e.g., input, delete, modify filter content instructions or information) from owner device 46_{D} through communications network 20.

Similarly, operator interface 74 serves as an interface or port through which filter configuration logic 70 of controller 52(10) receives filter specifications from an operator device 46_{E}. The filter specification(s) obtained from the operator device 46_{E} can ultimately be obtained from owner device 46_{D}, as represented by arrow 76 in FIG. 10. For example, the operator device 46_{E} can be, in one example embodiment, a web server maintained by the communications operator through which owner device 46_{D} can access the appropriate account (e.g., account 40₁) and thereby establish, delete, or modify filter data or parameters of the filters associated with the appropriate account.

Establishing, modifying, or deleting filter settings for a filter associated with the owner's account can be handled, either through communications network 20 and owner/telcom interface 72, or through the operator and operator interface 74, much in the same manner as changing settings on a cell phone account or on-line web-based account, e.g., through an appropriate menu drive selection process. Act 6-1 of FIG. 10 shows filter configuration logic 70 configuring (or reconfiguring, as the case may be) the contents or structure of a filter for customer account 40₁. It will be understood that filters for other accounts can likewise be (re)configured by filter configuration logic 70.

Thus, in view of the foregoing, it can be seen that the characteristic which is analyzed by account selection logic 32 can be selectively (re)configurable through actions implemented, e.g., by filter configuration logic 70.

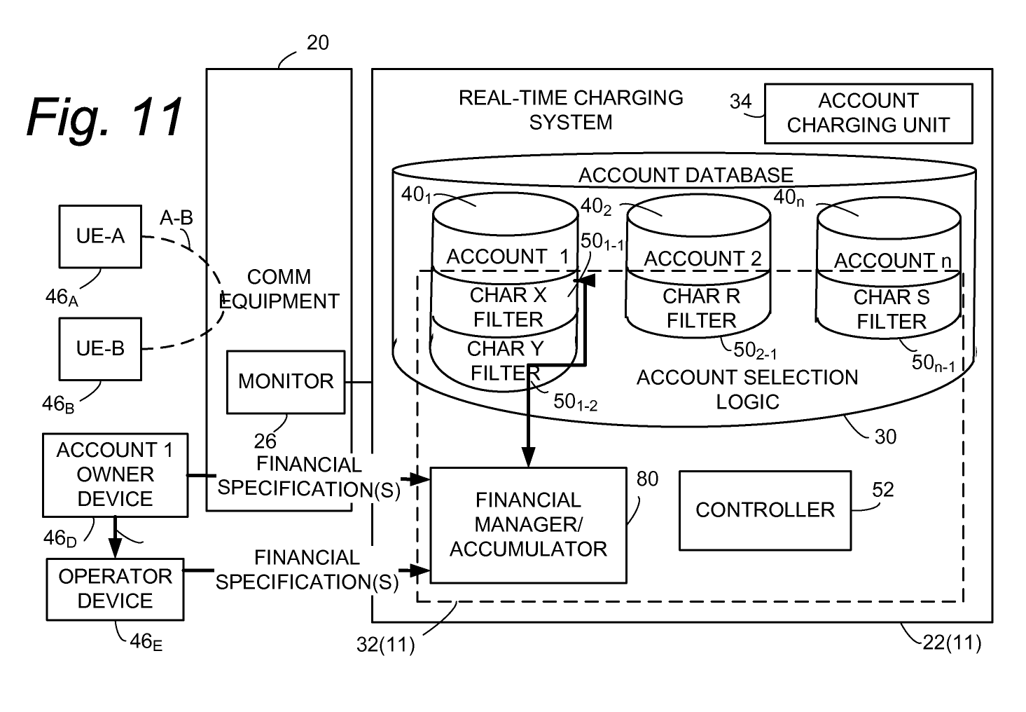

FIG. 11 illustrates an embodiment of a real-time charging system in which one or more filters comprise or have access to financial manager/accumulator 80. In the particular embodiment shown in FIG. 11, one account, i.e., customer accounts 40, happens to be linked to financial manager/accumulator 80. It should be understood that other accounts can also be linked or associated with the same or other financial managers/accumulators. Moreover, financial manager/accumulator 80 can be integrated in or included as part of an account, or be realized by controller 52, or any other aspect of account selection logic 32. The financial manager/accumulator 80 can be utilized to make an account or track, e.g., measure usage (e.g., of different services). For example, the owner of an account can (using financial manager/accumulator 80) set spending limits on how much the owner is willing to sponsor or allow another end-user to consume or utilize a certain service. Any excess of use by the other use can result in establishing a relation with another account, e.g., charging the relation account of the other user. Thus, the account selection logic 32(11) of FIG. 11 allows an account owner to set limits on or apportion the amount of use chargeable to his account (e.g., to account 40₁), and after such limit is exceed to set up or enforce a relation that causes a balance of the call or connection to be charged to another account (e.g., account 40₂). The parameters of financial manager/accumulator 80 such as the authorization limits, etc., can be interactively established in like manner as the filter specification as described with reference to FIG. 10.

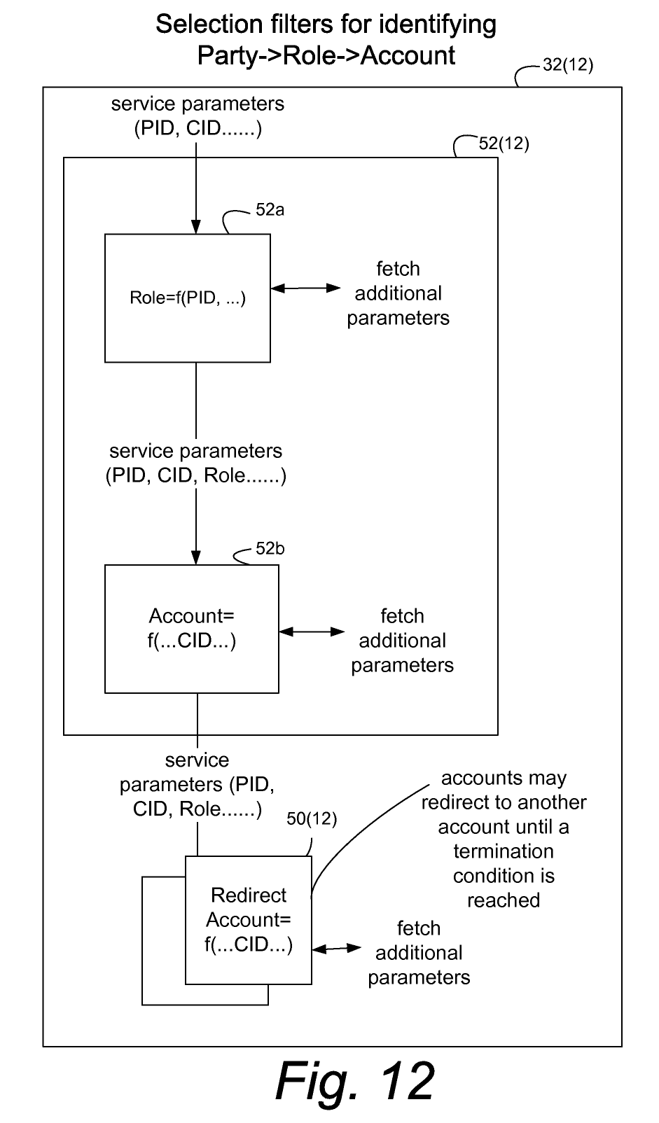

FIG. 12 shows an example embodiment of account selection logic 32(12) which provides an account redirection capability. The account selection logic 32(12) comprises controller 52(12). The controller 52(12) in turn comprises functional units such as example functional units 52a and 52b. In the example embodiment of FIG. 12, functional unit 52a comprises a role determination functional unit and functional unit 52b comprises an account determination functional unit.

The role determination functional unit 52a receives various service parameters (such as party identity [PID] and a contact identity [CID]) and, as a function of at least the PID and possibly other parameters, determines the role played by the party (e.g., by user 10). If necessary, role determination functional unit 52a can fetch other service parameters as inputs for its operation.

Account determination functional unit 52b receives various service parameters (e.g., PID, CID, and the “role” determined by role determination functional unit 52a) and determines a candidate account to be charged for the call placed by user 10. If necessary, account determination functional unit 52b can fetch other service parameters as inputs for its operation.

The controller 52(12) also comprises filter(s) 50(12). Although the account determination functional unit 52b may have selected a candidate account for charging, the filter(s) 50(12) can override the determination of account determination functional unit 52b and instead redirect the charge to another account. For example, the controller 52(12) may be programmed or configured to redirect a charge from one account to another account until some condition is fulfilled or satisfied, e.g., until some termination condition or the like is reached. If necessary, filter(s) 50(12) can fetch other service parameters as inputs for operation.

Thus, in the present technology, the role that a party plays when using a specific service can be used to determine which account is to be charged for the call or connection, not necessarily an account linked to the identity the party happens to be using. The technology thereby provides many advantages. One advantage is that an operator need only have one entry for each party. This in turn provides other benefits: (1) a party can get one bill/invoice/statement no matter what user identity the party may have used; (2) the operator can give promotions based on such criteria as the services the party is using, the time of day, the location, etc., and not the user identity; and (3) the party can use any user identity and be charged correctly.

Moreover, the technology affords an opportunity to define complex business rules without impact in the communications environment e.g. selection of sponsored calls/services for family or corporations. Sponsoring of a call does not necessarily need to be covered by the users own account e.g. children must always be able to call their family members and one of the parents accounts will carry the cost. The service filters could for instance act upon a dialed prefix and thereby let the end-users interact when selecting an account to carry the cost. Time-of-day, day-of-week and dates could be important input for the service filters. Charging scenario (service)-aware account differentiation, e.g., voice calls within a company, can be also carried by one account.

In accordance with the present technology, a customer (owner of an account) can also have the possibility to configure the service filters, and thereby decide for what other end-users and which charging scenarios he/she is going to carry the cost. Moreover, since it is known to connect accumulators to an account to, e.g., measure usage (e.g., of different services), the owner of an account can (using the accumulators) set spending limits on how much he/she is willing to sponsor or allow another end-user to consume or utilize a certain service.

Another advantage of the present technology is reduced signaling and CPU load in the communications network due, e.g., to the fact that the communications equipment does not need to be in control of the account relations and the fact that the charging system does not need to be interrogated separately for each involved account. Handling this relation internally in the charging system, compared to handling the relation by the communications equipment and the triggering of several session towards the charging system, reduces signaling and CPU load in the communications equipment.

The present technology thus may permit the redirecting of costs from one account to another (alternative) account. The present technology also permits the sharing of cost between plural customer accounts. For example, in some scenarios a call may be partially charged to a first account and partially charged to a second account.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method of operating a communications system comprising:
receiving a user identifier from a communications network in conjunction with a communications call or session, the user identifier being associated with a first account;
using a filter for the first account to make a determination whether the call should be associated with a second account;
charging the call to at least one account in accordance with the determination.

2. The method of claim 1, further comprising making the determination based on a characteristic of the call.

3. The method of claim 2, wherein the characteristic is selectively (re)configurable.

4. The method of claim 2, wherein the characteristic of the call is at least one of type of service utilized by the call; time of the call; location of a party to the call; particular user identity employed at authentication of the call.

5. The method of claim 2, further comprising:
initially associating the call to the first account in accordance with the user identifier;
using the filter for the first account to determine, based on the characteristic, whether the call should alternatively or partially be associated with the second account.

6. The method of claim 5, further comprising:
if the filter indicates that the call should be associated with the second account, using a second filter of the second account to make a confirmation whether the second account can be associated to the first account; and
if the confirmation can be made, charging the call to the second account.

7. The method of claim 6, further comprising, if the confirmation cannot be made, charging the call to the first account.

8. The method of claim 5, further comprising providing an interface through which the filter is configurable by an owner of the first account.

9. A charging system for a communications system comprising:
an information storage database comprising plural customer accounts;
account selection logic comprising a first filter associated with a first account, the first filter being configured to make a determination whether the call, having a user identifier which is associated with the first account, should be associated alternatively or partially with a second account;
an account charging unit configured to develop financially related information for the call.

10. The apparatus of claim 9, wherein the first filter is configured to make the determination based on a characteristic of a call.

11. The apparatus of claim 10, further comprising an interface to the account selection logic through which the characteristic is configurable.

12. The apparatus of claim 10, wherein the characteristic of the call is at least one of type of service utilized by the call; time of the call; location of a party to the call; particular user identity employed at authentication of the call.

13. The apparatus of claim 9, wherein the account selection logic comprises a set of filters and is further configured:
if the first filter indicates that the call should be associated with the second account, to use a second filter associated with the second account to make a confirmation whether the second account can be associated to the first account; and
if the confirmation can be made, to direct the charging unit to charge the call to the second account.

14. The apparatus of claim 14, wherein the account selection logic is further configured, if the confirmation cannot be made, to direct the charging unit to charge the call to the second account.

15. The apparatus of claim 9, further comprising an interface through which the first filter is configurable by an owner of the first account.

16. The apparatus of claim 9, further comprising an interface through which the account selection logic is configurable.
